(19) United States
(12) Patent Application Publication
(10) Pub. No.: US 2008/0201978 A1
(43) Pub. Date: Aug. 28, 2008

(54) Device For Drying Material

(76) Inventor: Asbjorn Hammer, Aafjord (NO)

Correspondence Address: DENNISON, SCHULTZ & MACDONALD, 1727 KING STREET, SUITE 105, ALEXANDRIA, VA, 22314, US

(21) Appl. No.: 11/722,953

(22) PCT Filed: Jan. 13, 2006
(86) PCT No.: PCT/NO06/00016

§ 371 Date: Jul. 2, 2007

(30) Foreign Application Priority Data
Jan. 13, 2005 (NO) 20050189

(51) Int. Cl. F26B 17/04; F26B 21/02; C05F 3/06; C02F 11/12; C02F 11/18; A01C 3/00

(52) U.S. Cl. 34/218; 34/205; 34/236

(57) ABSTRACT

Device for drying material, such as manure, mud and the like, comprising a grinding part and a drying part, as the drying part comprises at the least one conveyor belt (10) and an air heater (16). Above the conveyor belt it is arranged a closed air circulation system, leading air counter-current to the material on the conveyor belt. The temperature of the air heated in the heater (16), and the time wherein the material is dried, is adjusted in such a way that the dried material is free of bacteria and weed.

The present invention relates to a device for drying material, such as manure and mud, according to the preamble of patent claim 1. The device is particularly suited for drying chicken manure.

### BACKGROUND

At present, Norwegian authorities demand that if a farmer should have a given number of animals, he must have a correspondingly large area to spread the manure. For instance, one must have an area of ca 19 acre (300 Norwegian mål) in order to keep 5000 poultry. Thus, in some cases, the available area to spread manure will limit the number of animals the farmer can keep, and thereby the basis of income.

Norwegian authorities has also set limits as to when one may spread manure, it is not permissible to spread manure when there is snow and frozen ground. This means that it is not allowed to spread manure during the winter, and that the manure yard of the farm must be large enough to store all manure produced during this time.

Droppings from farm animals contain many nutrients, and have always been used as fertilizer to improve crops. Garden-owners, gardeners and others do not have access to farm animal manure, and a sales opportunity has therefore been developed, which also results in welcome extra income to the farm. However, direct sale of untreated farm animal droppings is undesirable and not practical, especially since untreated manure contains a lot of water. Besides, farm animal droppings smell rather strong, and untreated manure is therefore not very saleable.

From U.S. Pat. No. 6,471,989 there is known a plant for reducing the moisture content in wet materials, such as mud. The material is carried on conveyor belts and dried of air which may be dehumidified. However, this plant lacks a system for recycling the air and will thus add dust and odour to the surroundings. From WO 89/05989 there is known another plant, having partial recycling of air. None of the plants heat-treat the material, and the dried material may therefore contain both bacteria and weed. They will thus not be suitable for drying farm animal droppings.

### OBJECTS

The object of the present invention is to provide a device for drying material, such as manure, mud and the like, and that the dried material is designed in such a way that it may be used as a fertilizer having a mild smell and being relatively free of bacteria and weed, and that it is user friendly in small-scale. Another object is that the device and the production of the fertilizer should be cost-efficient.

### The Invention

A device according to the characterizing part of patent claim 1, may dry a moisture containing material to a product having a mild smell, and being relatively free of bacteria and weed.

With a device according to the present patent application, any material may be dried, at least a material that may be cut into smaller parts, such as fish waste, waste from the fruit- and vegetable-industry, but also manure from farm animals etc. However, the material must not be too wet (the content of dry substance should be above 50%), and must not contain too many long fragments (such as straws). If the share of long fragments gets to large, the device will more easily get clogged, and it will be difficult to cut the dried material into user friendly units. The end-product should preferably be used further, and in the following description the material is called manure, but this should not be interpreted as limiting to the scope of the invention.

The device according to the present invention comprises a grinding part (grinding mill) and a drying part. The manure is introduced into the grinding mill and ground before it is taken further to the drying part. The grinding mill comprises at least one row with at least one roll, and in those cases where the grinding mill comprises further rows, the rows are placed downstream of each other. The rolls rotate both ways, on interval control. The rolls are made with tearing elements on the outside, such that the manure is ground when it passes between the rolls or between a roll and the wall of the grinding mill.

By “tearing element” it is meant any element protruding from the surface of the roll, such as spikes, cogs or similar. In the simplest embodiment, the tearing element may be a relatively thin bar of stiff material. When the rolls rotate, the tearing elements should not bend away, but rather secure that the manure is torn into smaller fragments. If it is known that the material to be dried contains a large amount of long or particularly hard fragments, the tearing elements may be formed with, or as, knife-edges, so that the fragments are scattered before they are taken further in the process.

Downstream of the grinding mill there is a conveyor belt, in the following referred to as the first conveyor belt, taking the grinded manure into a cell-feeder. The cell-feeder is the entrance to the drying part and comminutes the manure onto a second conveyor belt leading to a screw conveyor, or another device taking the manure out of the drying part. It is an advantage to have a second cell-feeder at the other end of the second conveyor belt, comminuting the manure into the screw conveyor or other device taking the manure out of the drying part.

In this application, “cell-feeder” means a device comminuting the manure evenly, simultaneously as it works as a check valve, as neither gas, air nor any other material should be allowed to pass through the cell-feeder countercurrently with the manure. In it's simplest embodiment, the cell-feeder is a funnel having a four-sided cross section, in which there xis placed a roll in the lower part. The roll is inserted so that it fills the cross section of the funnel, but in such a way that manure may pass.

In a preferred embodiment the roll in such a cell-feeder is provided with grooves on a generally smooth surface. The manure will be pressed into these grooves and superfluous material will be removed when the roll is pressed against the wall of the funnel. With such an embodiment, the manure will come out of the cell-feeder as small units. If large fragments come into the cell-feeder, such an embodiment of the roll will also function as a grinding mill, as the large fragments will be cut when the roll rotates.

The conveyor belts being used in the present invention should preferably be of a dense kind. If a perforated belt is used, dust and small particles of the dried material will fall through the perforations. The dust may jam around the driving wheels or in other ways prevent a steady and continuous movement of the conveyor, and it may come into the machinery so it does not work well.

The screw conveyor may preferably be a flexible screw conveyor, i.e. inside the transport pipe is a flexible spring transporting the material, and the pipe itself is made of flexible material. With such a shape the whole screw conveyor becomes flexible, as it can be bent wherever one wants.

The conveyor belts, the screw conveyor and the rolls both in the grinding mill and the cell-feeders are preferably driven by electric motors, but may also be driven with by means, which will be obvious to a person skilled of the art.

A device according to the present invention, comprises further an air circulation system, the system as a whole is closed, air is neither added nor removed to/from the system. The circulation system blows air countercurrent to the manure along the second conveyor belt from the end of the drying part and towards the first cell-feeder. Above the conveyor belt, close to the first cell-feeder, is a vent drawing air away from the conveyor belt, through a heat exchanger and a heater before it is blown over the conveyor belt again, at the end of the drying part. In the heat exchanger the air is cooled down and the moisture is condensed and removed. The moisture may alternatively be used as liquid fertilizer. In most cases some particles will blend in with the air during the drying, and therefore the air should be filtrated before it is blown back onto the conveyor belt. To run the air draught a fan may be placed in the system, preferably after the heat exchanger before the heater.

To achieve a closed air circulation system, the whole drying part must be closed, and this may for example be done by physical separation and a cell-feeder in each end. A cell-feeder is, as said, embodied as a check valve, and air will not pass through. The physical separation may be achieved in several ways, for instance the drying-part may be placed in a separate room, or the second conveyor belt may be placed in a tunnel, wherein the cell-feeders are the inlet and the outlet of the tunnel. Air in the grinding mill or at the outlet of the device thus may not enter the drying part, and air in the drying part may not get out of it.

The filter, the heat exchanger and the heater of the circulation system may be embodied in several ways, which will be obvious to a person skilled of the art. However, it is a huge advantage if the filter is self-cleaning, and at the least it must be cleanable. Further, the heater may, for instance, comprise heating elements or a heat exchanger wherein the air draught is supplied with heat rather than submitting heat as in the previously mentioned heat exchanger.

The manure is ergo dried of the heated air draught passing countercurrently to the manure. It will be an advantage both upon storage and certainly upon later use, if the dried manure contains few bacteria. To achieve this, it is an advantage that the drying takes place at sufficiently high temperature and for sufficiently long time. Temperature and time influence each other, so that drying at higher temperature requires less time to achieve the same level of bacteria-removal, but a temperature of 70° C. in about 25 minutes will remove most bacteria (among others Salmonella), and is considered to be sufficient. In a specially preferred embodiment of the present invention, the air above the second conveyor belt is in average 85-95° C. (ca 120-125° C. close to blowoff and ca 70° C. close to vent), and it takes about 25 minutes from when the manure is introduced into the first cell-feeder, till it comes out of the drying part of the device. The temperature near vent (and thereby the need for heating) will vary, among others, with the solid content of the manure.

### EXAMPLE

In the following, the present invention will be described with reference to the accompanying drawings in which

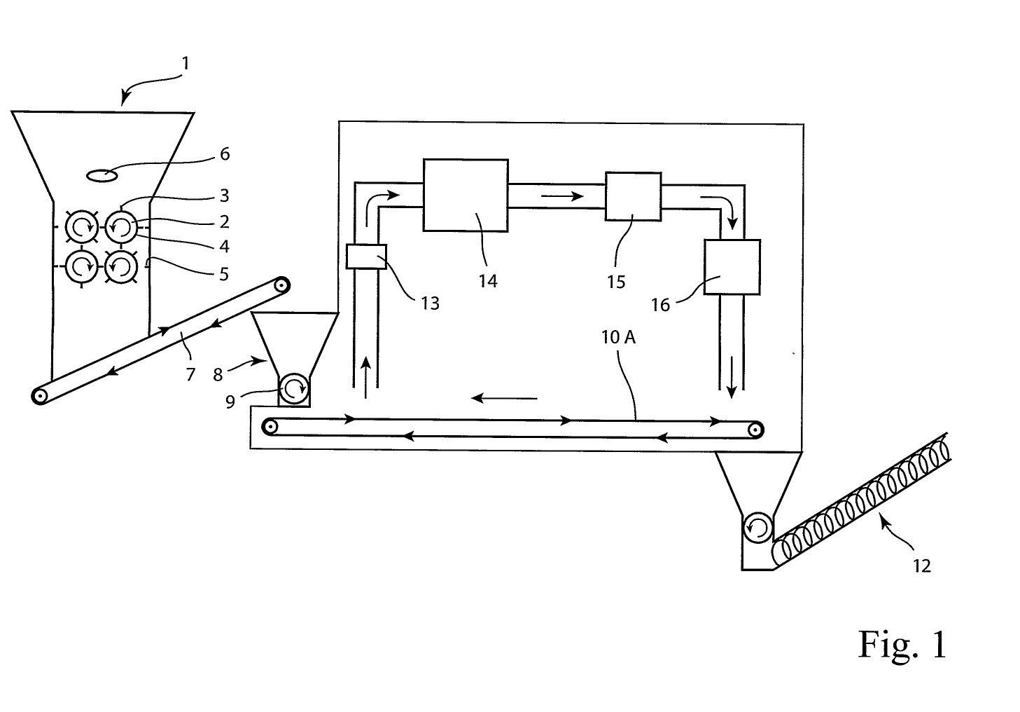

FIG. 1 shows a device according to the invention, and

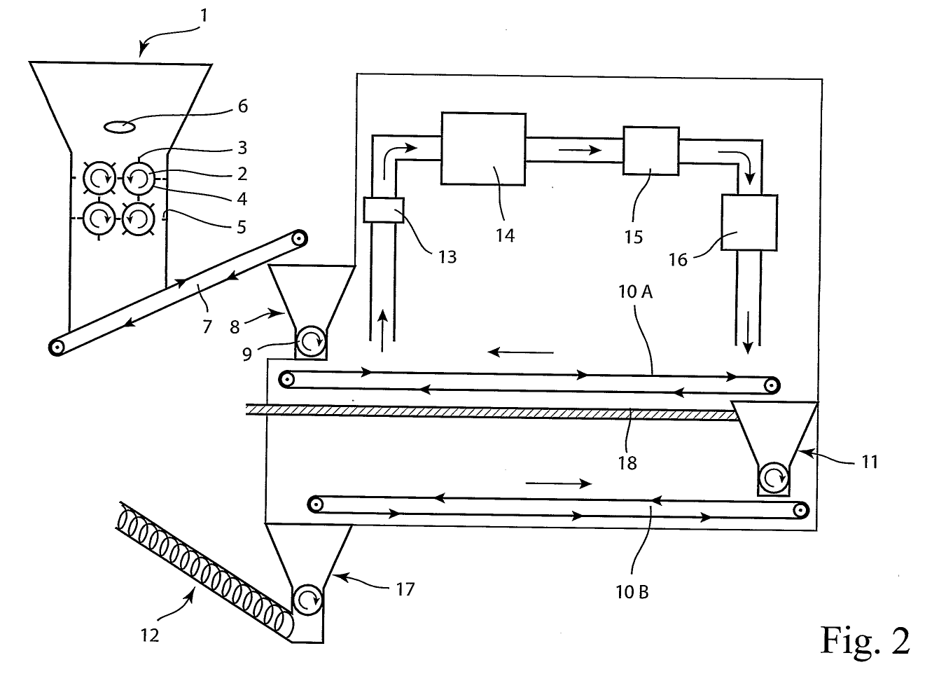

FIG. 2 shows a preferred embodiment of the invention.

The figures are illustrative, meaning that they are simplified and that the proportions may not be correct.

In FIG. 1 there is shown a grinding mill 1 having two rows of rolls, with two rolls 2 in each. All rolls 2 are provided with tearing elements 3. These are formed as sticks, as they have equal thickness along the whole length, and are fastened perpendicular to the outer surface 4 of the rolls 2. The rolls 2 are mounted in such a way that the tearing elements 3 almost reach the outer surface 4 of the adjacent roll. The inside of the wall of the grinding mill 1 is also provided with tearing elements 5, both at the level of the first and of the second row, so that the tearing elements 3 of the rolls also interfere with these elements 5.

Above the first row of rolls 2, there is mounted a vibrating device, in the following called vibrator 6. The purpose of this is to prevent material that is added to the grinding mill 1 getting lumpy in such a way that it does not fall down onto the rolls 2, but hangs above the rolls 2 as a bridge. The vibrator 6 vibrates at intervals, as constant vibration may have the opposite effect, i.e. the material is pressed together rather than getting porous. Like the conveyor belts and the rolls, it is driven by an electric motor, but may also be driven by other means.

Underneath the grinding mill 1 is placed a conveyor belt 7, in the following referred to as the first conveyor belt. This conveyor belt 7 is shown as sloping in FIG. 1, but it may of course be designed in many ways. The conveyor belt 7 leads to a first cell-feeder 8, in such a way that the manure falls into this. The first cell-feeder is provided with a controlling mechanism (not shown) controlling the grinding mill, as the level in the first cell-feeder should be kept between a maximum and a minimum level. The transportation from the grinding mill to the first cell-feeder may of course be done in many ways, with or without conveyor belts. The regulation of the speed of the grinding mill in relation to the cell-feeder may also be performed in many ways, which will be obvious to a person skilled of the art.

The cell-feeder 8 as shown is shaped as a funnel with a rectangular cross section, wherein a laterally placed, rotating roll 9 is mounted in the lower part, as stated above. The roll 9 is placed in such a way that the end-faces face the shorter walls of the rectangular cross section. The roll is provided with recesses or grooves on the surface (not shown). The size of these recesses decides the size of the units which the cell-feeder produces.

Underneath the first cell-feeder, is a second conveyor belt 10, leading to a second cell-feeder 11, and the units from this fall into a flexible screw conveyor 12, and is transported out of the device to storage.

Above the second conveyor belt 10, is the air circulation system. Air is drawn off at the beginning of the second conveyor belt 10 (i.e. close to the first cell-feeder 8), and is directed through a filter 13, a heat exchanger 14, a fan 15 creating the circulation, and a heater 16, before it is directed back to the end of the second conveyor belt 19 (i.e. close to the second cell-feeder 11). In the drawings the circulation system is drawn above the conveyor belt 10, but due to considerations of space, the circulation loop will in most cases be 90° to the plane of the drawing. The second conveyor belt 10 and the circulation system is physically separated from the rest of the device, in such a way that the air circulation system is completely closed. This is shown schematically with solid lines in the drawings.

FIG. 2 shows a preferred embodiment of the invention, wherein the second conveyor belt 10 is split in two parts, 10A and 10B, and the parts are placed on above the other. The parts are in the following referred to as the second 10A and third 10B conveyor belt. The second 10A and third 10B conveyor belts of FIG. 2 have the same function as the second conveyor belt 10 of FIG. 1, but are substantially shorter in length. In this embodiment the second cell-feeder 11 feeds units from the second conveyor belt 10A down onto the third conveyor belt 10B, instead of into the flexible screw conveyor 12 as shown in FIG. 1. The third conveyor belt 10B leads to a third cell feeder 17, which again leads to a flexible screw conveyor 12 in a similar way to the embodiment shown in FIG. 1. With this embodiment the device demands substantially less space.

The air is supposed to circulate above the third conveyor belt 10B, similar to the second conveyor belt 10 in FIG. 1, but this is not shown in the drawing in order to ease understanding of the drawing. The two circulation systems may be combined, so that there is only one filter 13, one heat exchanger 14 etc, but can also be kept completely separate.

The air draught should in the embodiment shown in FIG. 2, also go countercurrent of the manure, and this is indicated with an arrow to the left along the second conveyor belt 10A and towards the right along the third conveyor belt 10B. In this embodiment it is especially preferred that at least the second cell-feeder works as a check valve, so that air can not stream from the third conveyor belt 10B, up through the cell-feeder 12 and out on the second conveyor belt 10A. It can also be an advantage to separate the conveyor belts physically, for instance with a floor 18, as shown in FIG. 2.

1. Device for drying material, such as manure, mud and the like, comprising a grinding part and a drying part, wherein the drying part comprises at the least one conveyor belt (10) and an air heater (16), characterized in that a closed air circulation system comprising the air 5 heater, and directing the air countercurrent to the material on the conveyor belt, is arranged above the conveyor belt, the temperature of the air heated in the heater (16) and the time in which the material is dried, is adjusted in such a way that the dried material is free of bacteria and weed.

2. Device according to claim 1, characterized in that a cell feeder (8, 11) is arranged at the inlet and outlet of the drying part.

3. Device according to claim 2, characterized in that the lower part of the cell feeder (8) is provided with a roll (9) covering the cross section of the cell feeder (8).

4. Device according to claim 3, characterized in that the roll (9) has grooves or recesses in the outer face.

5. Device according to claim 1, characterized in that the air circulation system comprises a vent close to the cell feeder (8) at one end of the conveyor belt (10), and further a filter (13), a heat exchanger (14) and the heater (16), and the system is designed in such a way that the air is directed to the opposite end of the conveyor belt.

6. Device according to claim 1, characterized in that the circulation system comprises at least one fan (15) providing the circulation.

7. Device according to claim 1, characterized in that the conveyor belt (10) is split in two (10A and 10B) belts and separated by a cell feeder (11), the two parts of the conveyor belt (10A and 10B) are arranged on top of each other, and have separate air circulation systems.
